(19) United States
(12) Patent Application Publication
(10) Pub. No.: US 2013/0195323 A1
(43) Pub. Date: Aug. 1, 2013

(54) System for Generating Object Contours in 3D Medical Image Data

(71) Applicants: Danyu Liu, Hanover Park, IL (US); Matthias John, Nurnberg (DE)

(72) Inventors: Danyu Liu, Hanover Park, IL (US); Matthias John, Nurnberg (DE)

(21) Appl. No.: 13/358,530

(22) Filed: Jan. 26, 2012

(51) Int. Cl. G06K 9/00

(52) U.S. Cl. 382/128

(57) ABSTRACT

An image data processor processes 3D mesh data to identify an object boundary by, identifying for a first line segment between first and second points of the mesh, third and fourth points lying either side of the line segment, the first, second and third points comprising a first triangle and the first, second and fourth points comprising a second triangle. The image data processor determines a first normal vector for the first triangle and a second normal vector for the second triangle, determines a third normal vector perpendicular to a display screen, determines a first product of the first and third vectors and a second product of the second and third vectors and identifies the first line segment as a potential segment of the object boundary in response to the sign of the first and second products.

### FIELD OF THE INVENTION

This invention concerns an image data processing system for automatically detecting a boundary of an object in 3D (three dimensional) medical image data.

### BACKGROUND OF THE INVENTION

It is often desired to draw a contour and outline of an object in three dimensional (3D) medical image data representing an anatomical volume. For example, it may be necessary to visualize a vessel outline through which a catheter is to be guided to a detected tumor or lesion for use in applying a surgical procedure to the tumor. In known systems an image showing a 3D contour of an Aorta, for example, is presented on a monitor in order to aid a physician place an artificial aortic valve on top of a malfunctioning valve. One known system generates a 3D outline contour for an object of interest by displaying an Aorta surface in a 3D image view on a monitor, capturing the displayed image data and by using a known boundary tracing method to generate the outline contour. In this known system, the generated outline is not smooth and the method is typically computation intensive and slow and the 3D image view often does not match a user interpretation. FIG. 1 shows a an object outline contour generated by a prior art system that comprises an overlay placed on top of a three dimensional (3D) image view. This outline contour lacks a 3D look and feel and is sensitive to rendering order

Another known system involves generating and use of an Aorta mesh outline. FIGS. 2 and 3 show an Aorta mesh (i.e. a tube structure) outline generated by a known system and substantially comprising two rough lines presented on top of a 3D image view that lacks a 3D image view look and feel. Further, in the FIGS. 2 and 3 outlines, the aorta outline ending is missing. In another known system, an outline is generated based on a binary mask by a known random walker segmentation process as illustrated in FIG. 4. The generated outline is not smooth and lacks a 3D image view look and feel and quality of the outline is degraded. A system according to invention principles addresses these deficiencies and related problems.

### SUMMARY OF THE INVENTION

A system generates an outline that looks smooth in real-time with a 3D look and feel and identifies hidden lines whilst remaining insensitive to the rendering order of objects. An image data processing system automatically detects a boundary of an object in 3D (three dimensional) medical image data using a repository and image data processor. The repository includes a 3D (three dimensional) image dataset comprising data representing a 3D mesh of individual points of an anatomical volume of interest. The image data processor processes the 3D mesh data retrieved from the repository to identify an object boundary by, identifying for a first line segment between first and second points of the mesh, third and fourth points lying either side of the line segment, the first, second and third points comprising a first triangle and the first, second and fourth points comprising a second triangle. The image data processor determines a first normal vector for the first triangle and a second normal vector for the second triangle, determines a third normal vector perpendicular to a display screen, determines a first product of the first and third vectors and a second product of the second and third vectors and identifies the first line segment as a potential segment of the object boundary that is viewable by a user on the display screen in response to the sign of the first and second products.

### BRIEF DESCRIPTION OF THE DRAWING

FIG. 1 shows a an object outline generated by a prior art system and comprising an overlay placed on top of a three dimensional (3D) image view.

FIGS. 2 and 3 show an Aorta mesh (i.e. a tube structure) outline generated by a prior art system and substantially comprising two rough lines presented on top of a 3D image view that lacks a 3D image view look and feel.

FIG. 4 shows an image object outline generated based on a binary mask by a known random walker segmentation process.

FIG. 5 shows an image data processing system for automatically detecting a boundary of an object in 3D (three dimensional) medical image data, according to invention principles.

FIG. 6 shows a process for automatically determining a boundary surface of an object in 3D (three dimensional) medical image data, according to invention principles.

FIG. 7 shows a system for automatically detecting individual line segments comprising a boundary of an object in 3D (three dimensional) medical image data, according to invention principles.

FIG. 8 shows a volume image of an object.

FIG. 9 shows a binary mask image of the object of FIG. 8.

FIG. 10 shows a mesh image derived from the binary mask image of the object of FIG. 8.

FIG. 11 shows a volume object mesh image showing a detected outline matching the mesh volume, according to invention principles.

FIG. 12 illustrates a volume object image boundary illustrating a hidden boundary segment, according to invention principles.

FIG. 13 shows a detected edge of a volume object image mesh, according to invention principles.

FIG. 14 shows a flowchart of a process employed by an image data processing system for automatically detecting a boundary of an object in 3D (three dimensional) medical image data, according to invention principles.

### DETAILED DESCRIPTION OF THE INVENTION

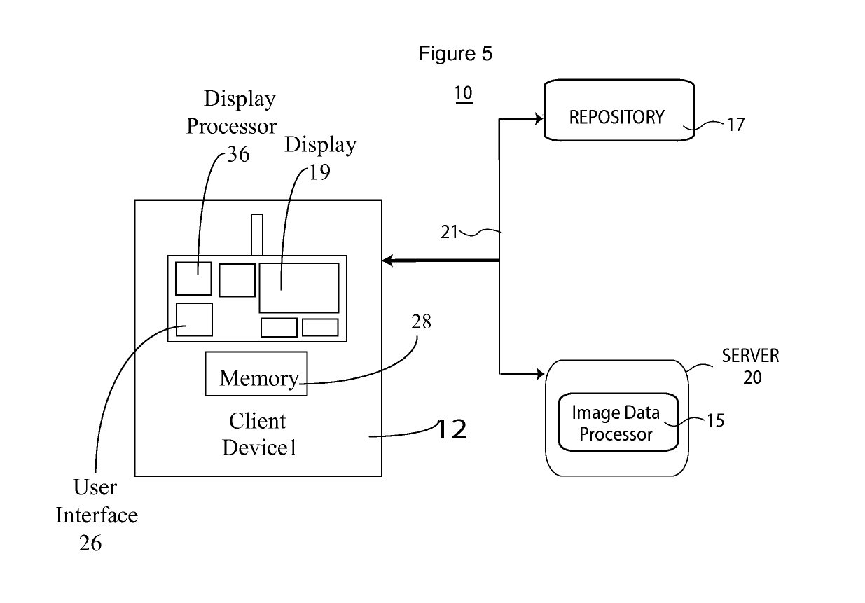

A system generates an outline that looks smooth in real-time with a 3D look and feel and identifies hidden lines whilst remaining insensitive to the rendering order of objects. FIG. 5 shows image data processing system 10 for automatically detecting a boundary of an object in 3D (three dimensional) medical image data. System 10 includes one or more processing devices (e.g., computers, workstations or portable devices such as notebooks, Personal Digital Assistants, phones) 12 that individually include a user interface (e.g., a cursor) device 26 such as a keyboard, mouse, touchscreen, voice data entry and interpretation device, at least one display monitor 19, display processor 36 and memory 28. System 10 also includes at least one repository 17 and server 20 intercommunicating via network 21. Display processor 36 provides data representing display images comprising a Graphical User Interface (GUI) for presentation on at least one display 19 of processing device 12 in response to user commands entered using device 26. At least one repository 17 stores 2D and 3D image datasets comprising medical image studies for multiple patients in DICOM compatible (or other) data format. The 3D image datasets comprise data representing a 3D mesh of individual points of an anatomical volume of interest. A medical image study individually includes multiple image series of a patient anatomical portion which in turn individually include multiple images.

Server 20 includes image data processor 15. In alternative arrangements, image data processor 15 may be located in device 12 or in another device connected to network 21. Repository 17 includes a 3D (three dimensional) image dataset representing an anatomical volume of interest. Image data processor 15 processes the 3D mesh data retrieved from repository 17 to identify an object boundary by, identifying for a first line segment between first and second points of the mesh, third and fourth points lying either side of the line segment, the first, second and third points comprising a first triangle and the first, second and fourth points comprising a second triangle. Processor 15 determines a first normal vector for the first triangle and a second normal vector for the second triangle and determines a third normal vector perpendicular to a display screen. Processor 15 determines a first product of the first and third vectors and a second product of the second and third vectors and identifies the first line segment as a potential segment of the object boundary that is viewable by a user on the display 19 screen in response to the sign of the first and second products. In addition processor 15 employs a hidden point detection function to determine if any of the ending points of the line segment are visible. Display processor 36 initiates generation of a display image including the object and displays the line segment as a portion of the object boundary in response to the line segment ending points being visible.

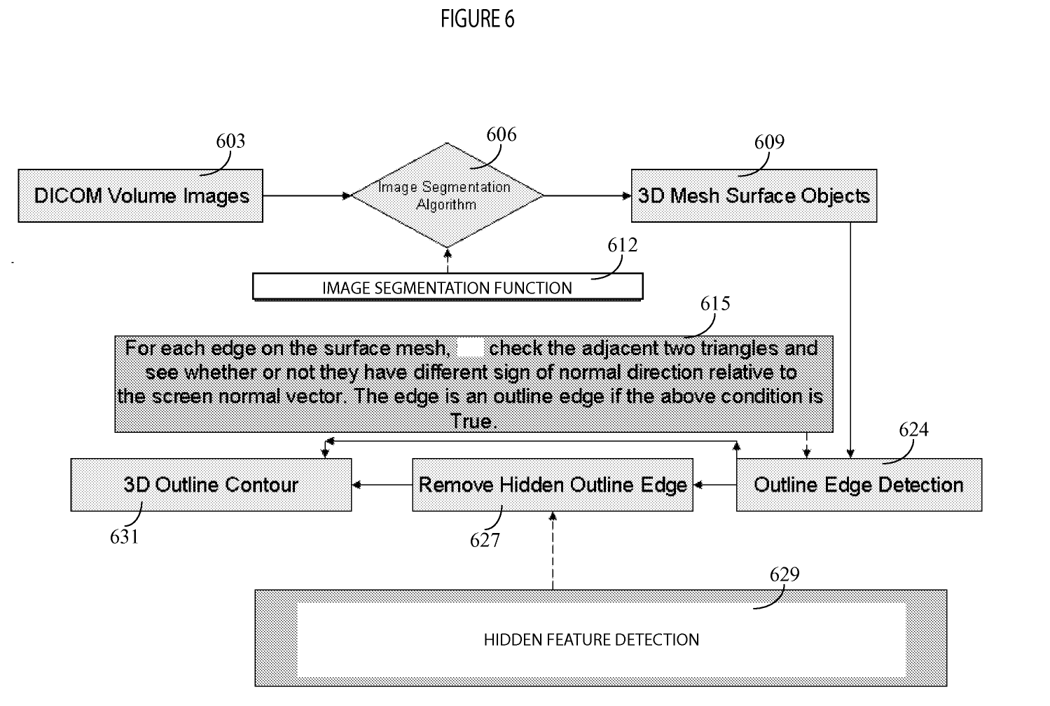

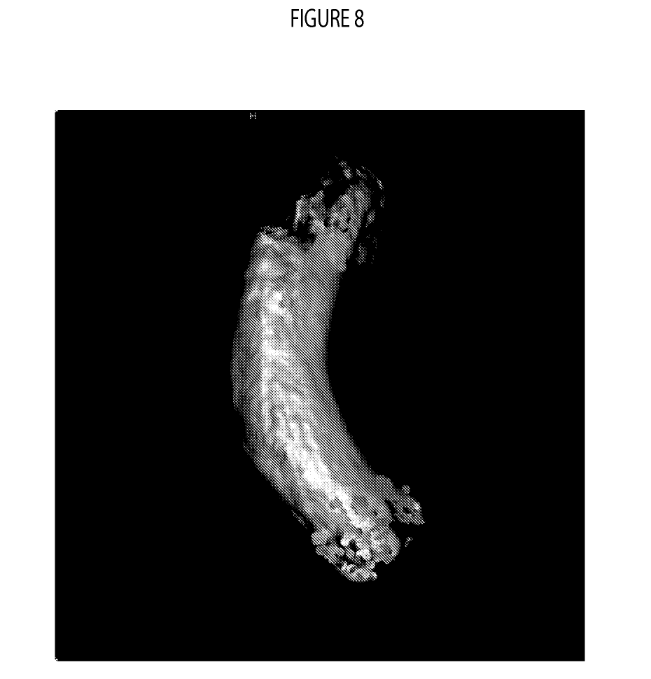

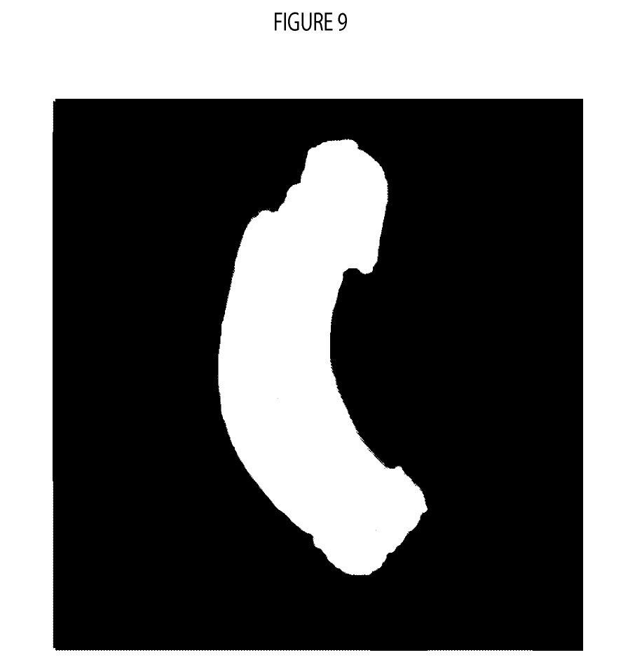

FIG. 6 shows a process for automatically determining a boundary surface of an object in 3D (three dimensional) medical image data such as the volume image of the object of FIG. 8. System 10 (FIG. 5) generates an outline that looks smooth in real-time with a 3D look and feel and the system provides a function to turn on and off a hidden line detection function. The system advantageously includes an efficient mesh-surface-based object contour generation method that generates an outline based on an object mesh whilst remaining insensitive to a rendering order of objects. The generated outline is not sensitive to the rendering order is because it is based on a generated mesh rather than screen-capture image. Image data processor 15 (FIG. 5) in step 606 performs image segmentation on a DICOM compatible 3D image dataset acquired in step 603 to identify image object (e.g. vessel, organ, bone and other) structure boundaries using known image segmentation function 612. Processor 15 obtains a binary mask of an object of interest in a 3D image volume dataset. FIG. 9 shows a binary mask image generated for the object of FIG. 8.

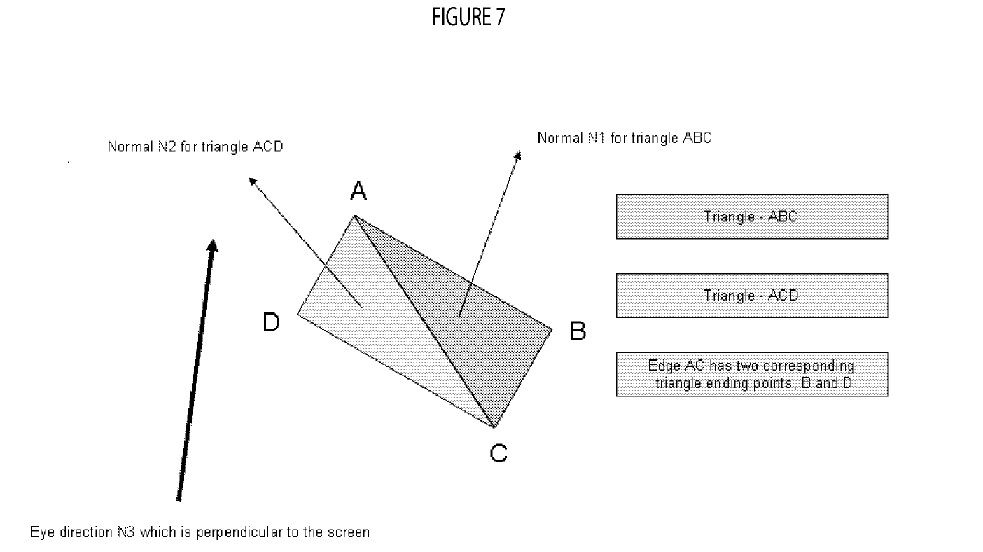

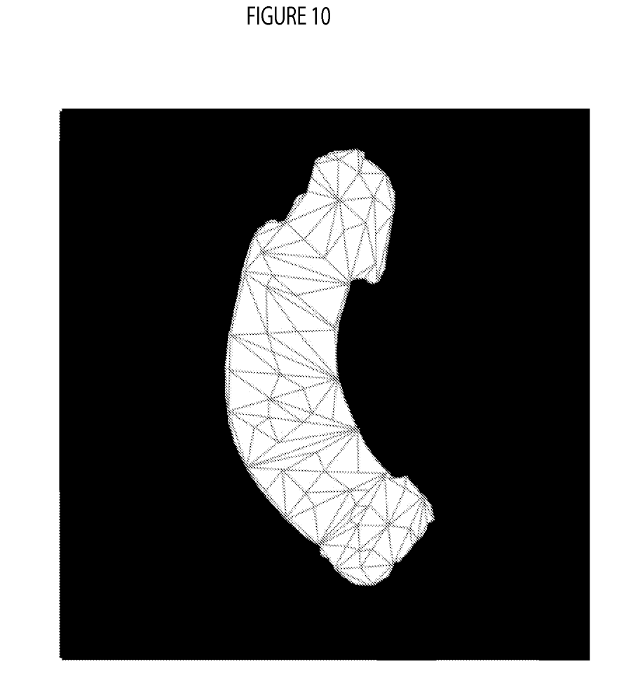

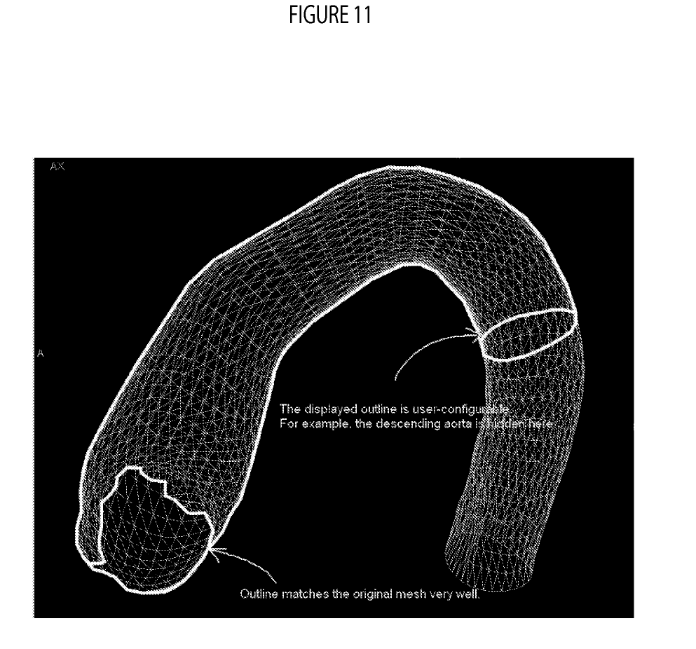

Processor 15 in step 609 identifies and selects points on the structure boundaries and generates 3D object surface mesh structure data using the identified points. Processor 15 generates a 3D mesh surface structure by applying a marching cube function to the binary mask and searches edges on the object mesh to find the edges that are the outline of the object. A marching cube function is a known function used for extracting a polygonal mesh of an isosurface from a three-dimensional scalar field (sometimes called voxels) by taking eight neighbor locations at a time (thus forming an imaginary cube) and determining the polygon(s) needed to represent the part of the isosurface that passes through this cube and the polygons are combined to form a desired surface (William E. Lorensen, Harvey E. Cline: Marching Cubes: A high resolution 3D surface construction algorithm. In: Computer Graphics, Vol. 21, Nr. 4, July 1987). FIG. 10 shows a mesh image derived by system 10 (FIG. 5) from the binary mask image of the object of FIG. 8. FIG. 11 shows a volume object mesh image showing a detected outline matching the mesh volume. Processor 15 in step 624 processes the generated mesh data using a system 615 as shown in FIG. 7 for automatically detecting individual line segments comprising a surface boundary. FIG. 7 shows a system for automatically detecting individual line segments comprising a boundary of an object in 3D (three dimensional) medical image data. The generated object mesh is searched and for each triangle on a surface, a normal of the surface (i.e. N1 and N2 in FIG. 7) is computed. Also, for each edge (e.g. line AC in FIG. 7) on the surface mesh, the corresponding two triangle points (i.e. point B and D in FIG. 7) on each side of the line are recorded. N3 is a normal that is perpendicular to the screen (i.e. eye direction). For each different image update, the dot products between N1 and N3 and N2 and N3 are computed. A dot product of two vectors a=[a1, a2, . . . , an] and b=[b1, b2, . . . , bn] is defined as: a·b=sum[ai * bi] where i starts from i=1 to n.

Processor 15 identifies the line segment AC as a potential segment of an object boundary that is viewable by a user on the display screen in response to the sign of the first and second products. Processor 15 computes a surface normal for a triangle by taking the vector cross product of two edges of that triangle. The order of the vertices used in the calculation will affect the direction of the normal (in or out of the triangle). For a triangle A, B, C, if an edge vector U=B−A and an edge vector V=C−A then the normal N =U X V is calculated by:

Nx=UyVz−UzVy

Ny=UzVx−UxVz

Nz=UxVy−UyVx

For each edge (i.e. AC) on a surface, a map is generated by mapping edge AC to point X and point Y (point Y may be currently unknown). Triangle ACB contains edge AC with vertice B, for example and the mesh structure is updated as edge AC is mapped to point X (i.e. B) and point Y (currently unknown). Triangle ACD contains edge AC with vertice D. and the mesh structure is updated by mapping edge AC to point X (i.e. B) and point Y (i.e. D). Given edge AC and point B, corresponding vertice on the other side is determined as D.

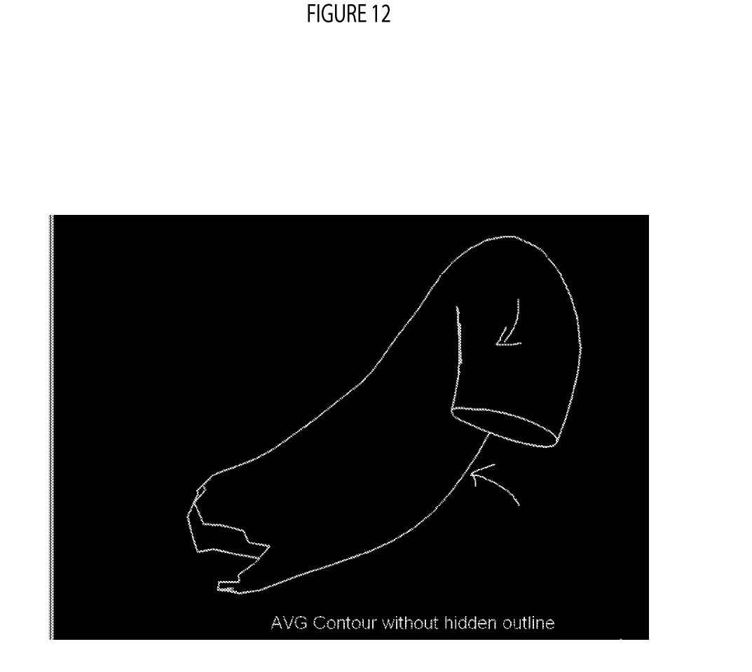

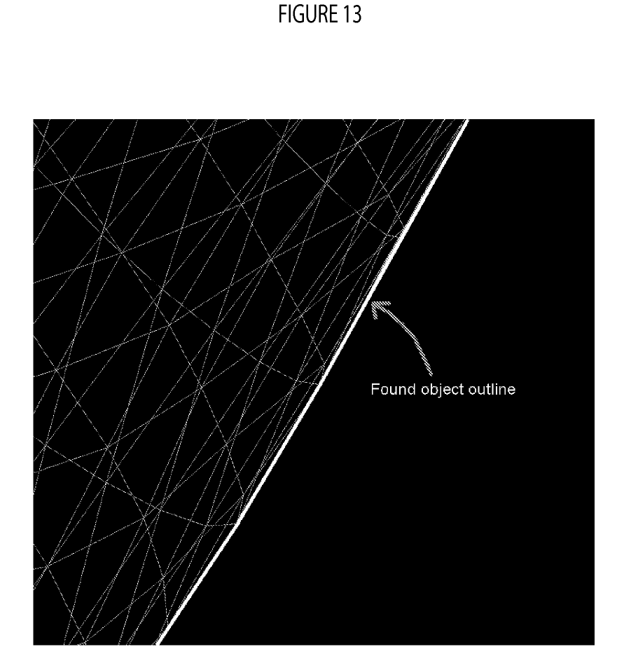

Processor 15 in step 627 applies hidden point detection function 629 to determine if any of the ending points of line segment AC are visible. The hidden point detection function is described in Published U.S. Patent Application 2011/0072397 by S. Baker et al. If any of the ending points of the edge are visible, the edge is displayed as the final outline for the 3D object in step 631. FIG. 13 shows a detected edge of a volume object image mesh. Function 629 removes detected outlines that are not visible to a user on the display screen. The system generates an outline that looks smooth in real-time with a 3D look and feel and enables turn on/off hidden line detection function 629. Display processor 36 initiates generation of a display image including the object and line segment AC as a portion of the object boundary that is viewable by a user on the display screen in response to the ending points being visible and hiding boundaries that not visible to a user. FIG. 12 illustrates a volume object image boundary illustrating a hidden boundary segment.

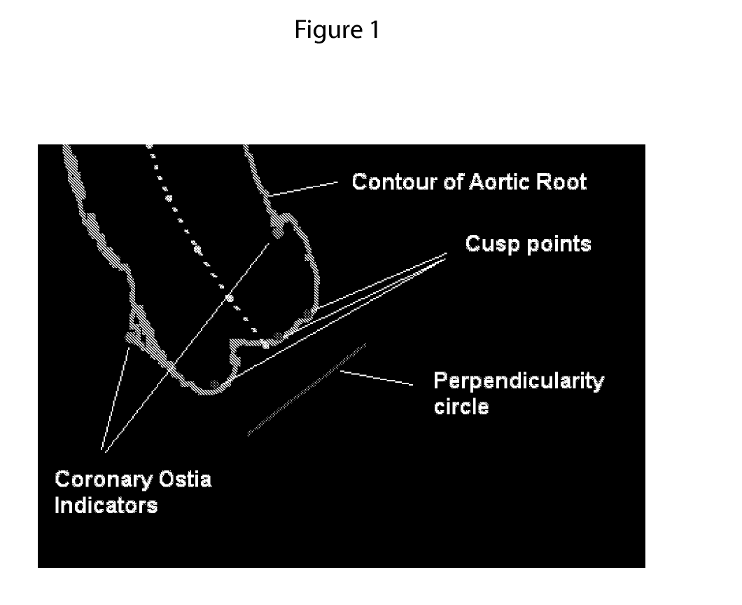

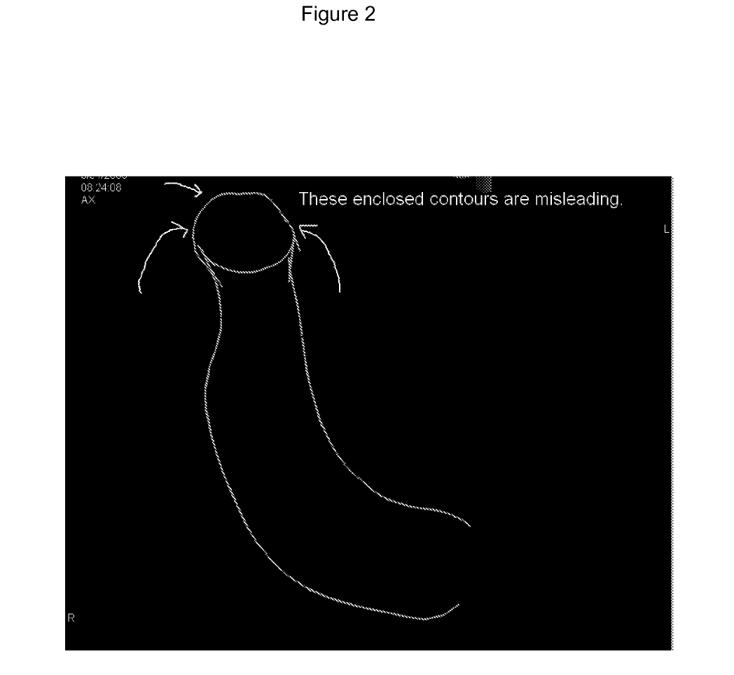

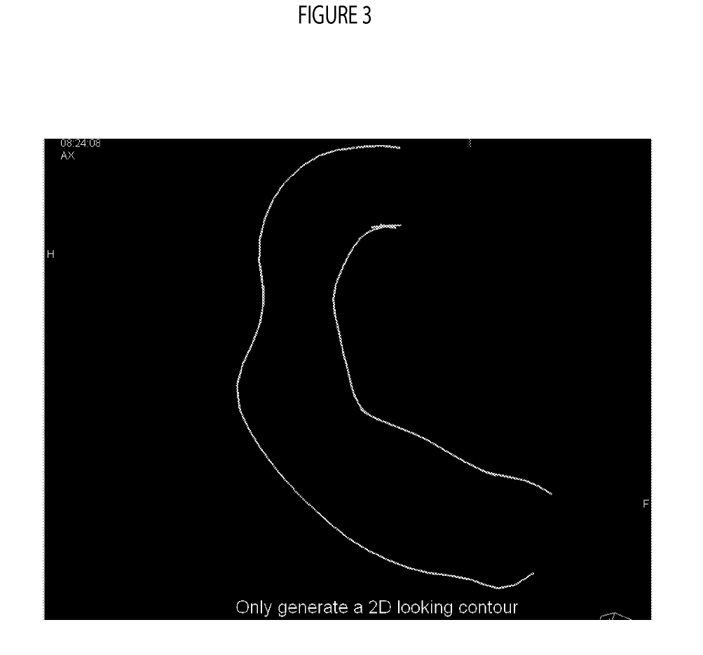

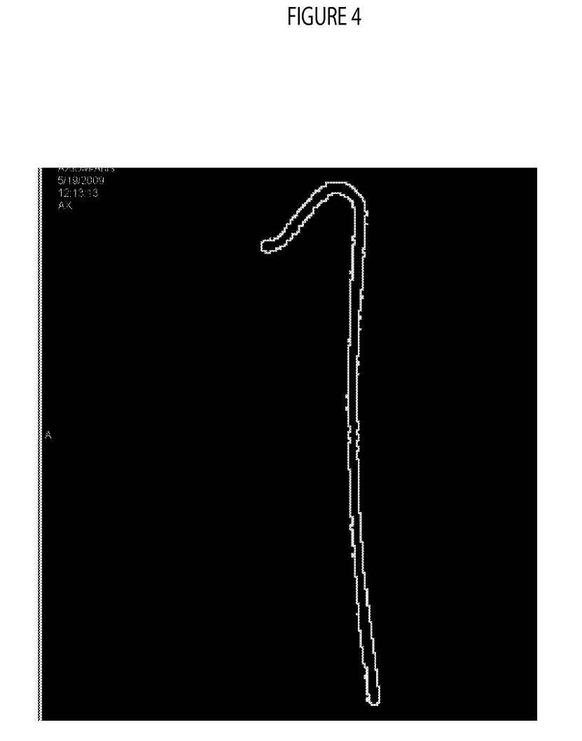

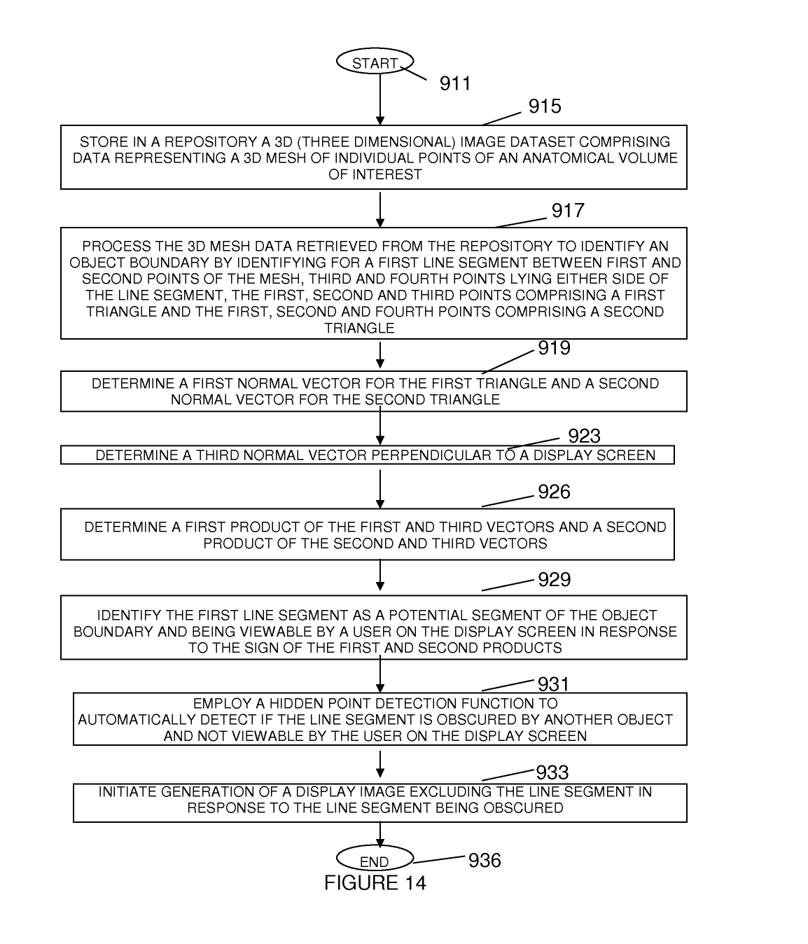

FIG. 14 shows a flowchart of a process employed by image data processing system 10 (FIG. 1) for automatically detecting a boundary of an object in 3D (three dimensional) medical image data. Image data processor 15 in step 915 following the start at step 911, stores in repository 17 a 3D (three dimensional) image dataset comprising data representing a 3D mesh of individual points of an anatomical volume of interest. In step 917, processor 15 processes the 3D mesh data retrieved from repository 17 to identify an object boundary by identifying for a first line segment between first and second points of the mesh, third and fourth points lying either side of the line segment, the first, second and third points comprising a first triangle and the first, second and fourth points comprising a second triangle.

In step 919 processor 15 determines a first normal vector for the first triangle and a second normal vector for the second triangle and in step 923 determines a third normal vector perpendicular to a display screen. In step 926 processor 15 determines a first product of the first and third vectors and a second product of the second and third vectors and in step 929 identifies the first line segment as a potential segment of the object boundary that is viewable by a user on the display 19 screen in response to the sign of the first and second products being different. In one embodiment the first and second products are dot products. Processor 15 in step 931 employs a hidden point detection function to automatically detect if the line segment is obscured by another object and is not viewable by the user on the display screen. The hidden point detection function also determines if any of the ending points of the line segment are viewable by the user on the display screen. Further, in step 933 display processor 36 initiates generation of a display image excluding the line segment in response to the line segment being obscured and in another embodiment including the object and the line segment as a portion of the object boundary in response to the ending points (the first and second points) being visible. The process of FIG. 14 terminates at step 936.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a controller, computer or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 8) herein may be performed automatically or wholly or partially in response to user command An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

The system and processes of FIGS. 5-14 are not exclusive. Other systems and processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. A system processes the 3D mesh image data to identify an object boundary line segment between points of the mesh that is a potential segment of the object boundary and is viewable by a user on a display screen in response to determination of a product of normal vectors derived for adjacent mesh triangles and a display screen normal. In addition processor 15 employs a hidden point detection function to determine if any of the ending points of the line segment are visible. Further, the processes and applications may, in alternative embodiments, be located on one or more (e.g., distributed) processing devices on a network linking the units of FIG. 5. Any of the functions and steps provided in FIGS. 5-14 may be implemented in hardware, software or a combination of both.

What is claimed is:

1. An image data processing system for automatically detecting a boundary of an object in 3D (three dimensional) medical image data, comprising:
a repository including a 3D (three dimensional) image dataset comprising data representing a 3D mesh of individual points of an anatomical volume of interest;
an image data processor for processing the 3D mesh data retrieved from said repository to identify an object boundary by,
(a) identifying for a first line segment between first and second points of the mesh, third and fourth points lying either side of the line segment, the first, second and third points comprising a first triangle and the first, second and fourth points comprising a second triangle,
(b) determining a first normal vector for the first triangle and a second normal vector for the second triangle,
(c) determining a third normal vector perpendicular to a display screen,
(d) determining a first product of the first and third vectors and a second product of the second and third vectors and
(e) identifying the first line segment as a potential segment of said object boundary and being viewable by a user on said display screen in response to the sign of the first and second products.

2. A system according to claim 1, wherein
said first and second products are dot products.

3. A system according to claim 1, wherein
said image data processor identifies the first line segment as a potential segment of said object boundary in response to the sign of the first and second products being different.

4. A system according to claim 1, wherein
said image data processor employs a hidden point detection function to determine if any of the ending points of the line segment are viewable by said user on said display screen and including
a display processor for initiating generation of a display image including the object and displaying the line segment as a portion of the object boundary in response to said ending points being visible.

5. A system according to claim 4, wherein
said ending points comprise said first and second points.

6. A system according to claim 1, wherein
said image data processor employs a hidden point detection function to automatically detect if said line segment is obscured by another object and not viewable by said user on said display screen and including
a display processor for initiating generation of a display image excluding said line segment in response to said line segment being obscured.

7. An image data processing method for automatically detecting a boundary of an object in 3D (three dimensional) medical image data, comprising the activities of:
storing in a repository a 3D (three dimensional) image dataset comprising data representing a 3D mesh of individual points of an anatomical volume of interest;
processing the 3D mesh data retrieved from said repository to identify an object boundary by,
(a) identifying for a first line segment between first and second points of the mesh, third and fourth points lying either side of the line segment, the first, second and third points comprising a first triangle and the first, second and fourth points comprising a second triangle,
(b) determining a first normal vector for the first triangle and a second normal vector for the second triangle,
(c) determining a third normal vector perpendicular to a display screen,
(d) determining a first product of the first and third vectors and a second product of the second and third vectors and
(e) identifying the first line segment as a potential segment of said object boundary and being viewable by a user on said display screen in response to the sign of the first and second products.

8. A method according to claim 7, wherein
said first and second products are dot products.

9. A method according to claim 7, wherein
said activity of identifying said first line segment comprises identifying said first line segment as a potential segment of said object boundary in response to the sign of the first and second products being different.

10. A method according to claim 7, including the activities of
employing a hidden point detection function to determine if any of the ending points of the line segment are viewable by said user on said display screen and
initiating generation of a display image including the object and displaying the line segment as a portion of the object boundary in response to said ending points being visible.

11. A method according to claim 10, wherein
said ending points comprise said first and second points.

12. A method according to claim 7, including the activities of
employing a hidden point detection function to automatically detect if said line segment is obscured by another object and not viewable by said user on said display screen and
initiating generation of a display image excluding said line segment in response to said line segment being obscured.
